(19) United States
(12) Patent Application Publication
(10) Pub. No.: US 2011/0294307 A1
(43) Pub. Date: Dec. 1, 2011

(54) PCB HAVING CONNECTOR SOCKET MATING WITH TERMINAL PLUG OF FPCB

(75) Inventor: MING-YUAN HSU, Tu-Cheng (TW)

(73) Assignee: HON HAI PRECISION INDUSTRY CO., LTD., Tu-Cheng (TW)

(21) Appl. No.: 12/835,883

(22) Filed: Jul. 14, 2010

(30) Foreign Application Priority Data
May 31, 2010 (TW) 99117484

(51) Int. Cl. H01R 12/14

(52) U.S. Cl. 439/55

(57) ABSTRACT

A PCB includes a mounting surface, a face-down connector socket, a face-up connector socket, and a number of electronic components. The mounting surface defines two connector outlines arranged in a back-to-back fashion. The face-down connector socket and the face-down connector socket are selectively mounted to the mounting surface within the corresponding connector outlines to facilitate a connection with a terminal plug of an FPCB. The electronic components are mounted to the mounting surface, outside the connector outlines.

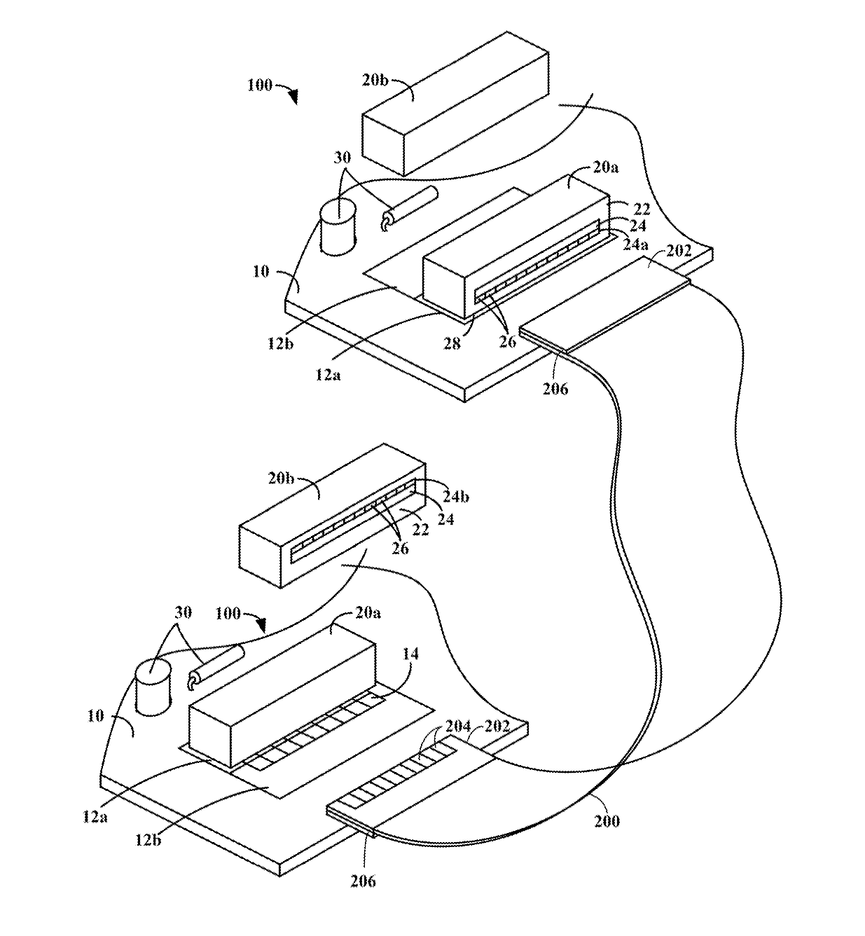

### BACKGROUND

1. Technical Field

The present disclosure relates to printed circuit boards (PCBs) and, particularly, to a PCB having a connector socket mating with a terminal plug of a flexible PCB (FPCB).

2. Description of Related Art

Generally, two PCBs can be connected through an FPCB. Each PCB includes a connector socket. The FPCB includes two terminal plugs. The PCBs are connected by plugging the terminal plugs into the connector sockets of the PCBs. The connector sockets can be a face-up or face-down connector socket. The face-up connector socket requires the terminal plug to plug in with contacts thereof faced up, while the face-down connector socket requires the terminal plug to plug in with the contacts thereof faced down. However, if configurations (including positions of the PCBs, types of the connector sockets, and positions of the connector sockets on the PCBs) of the PCBs are fixed, it is not uncommon that the types and positions of the connector sockets do not facilitate the connection of the PCBs. For example, it may require that the FPCB be twisted to meet the type of the connector sockets or sometimes, it requires a longer length of the FPCB because the FPCB is shortened due to the twist. To facilitate the connection of the PCBs, the connector socket of an unfitted type can be replaced with one of a fitted type. However, this requires a great deal of effort and redesign of the PCBs because the replacement may interfere with other electronic components of the PCBs and change the circuitry of the PCBs.

Therefore, it is desirable to provide a PCB, which can overcome the above-mentioned limitations.

### BRIEF DESCRIPTION OF THE DRAWING

Many aspects of the present PCB can be better understood with reference to the following drawing. The components in the drawings are not necessarily drawn to scale, the emphasis instead being placed upon clearly illustrating the principles of the present PCB.

The FIGURE is a schematic view showing two PCBs and an FPCB, according to an embodiment.

### DETAILED DESCRIPTION

Embodiments of the present PCB will now be described in detail with reference to the drawing.

Referring to the FIGURE, two PCBs 100 and an FPCB 200, according to an embodiment, are illustrated. The PCBs 100 can be connected through the FPCB 200. The FPCB 200 includes two terminal plugs 202. Each of the terminal plugs 202 forms a line of electrical contacts 204 on one surface thereof (not labeled) and is attached with a reinforcing plate 206 on an opposite surface thereof (not labeled).

Each of the PCBs 100 includes a mounting surface 10, a face-down connector socket 20a, a face-up connector socket 20b, and a number of electronic components 30. The mounting surface 10 includes two connector outlines 12a and 12b configured for indicating positions for mounting the corresponding connector sockets 20a and 20b thereto. The connector outlines 12a and 12b are arranged in a back-to-back fashion, that is, the connector outlines 12a and 12b connect with each other but are opposite to each other. The face-down connector socket 20a is configured to allow the terminal plugs 202 to plug in with the contacts 204 thereof faced down. The face-up connector socket 20b is configured to allow the connector plugs 202 to plug in with the electrical contacts 204 thereof faced up. The PCB 100 is configured such that the electronic components 30 are located outside the two connector outlines 12a and 12b.

As such, free from interfering with other electronic components 30 or redesigning the PCB 100, the connector sockets 20a and 20b can be selectively mounted into the PCB 100 to facilitate a connection of the PCBs 100. For example, as shown in the figure, if the face-up connector socket 20b which is already mounted to the lower PCB 100 does not facilitate the terminal plug 202 to plug therein, the face-up connector socket 20b can be replaced by the face-down connector socket 20a without redesigning the lower PCB 100.

In particular, the PCB 100 includes a line of pads 14 arranged at a common boundary of the two connector outlines 12a and 12b. The pads 14 are connected to circuits (not shown) formed in the PCB 100. Each of the connector sockets 20a and 20b defines an insertion groove 24 in a side surface 22 thereof and includes a set of pins 26 extending from a bottom surface 28 thereof. The pins 26 of the connector socket 20a extend to a bottom portion 24a of the insertion groove 24. The pins 26 of the connector socket 20b extend to an upper portion 24b of the insertion groove 24. As such, when the connector sockets 20a and 20b are disposed on the PCB 100, within the corresponding connector outlines 12a and 12b, the pins 26 are connected to the pads 14 and thus the connector sockets 20a and 20b and the circuits formed in the PCB 100 form a complete circuit.

The electronic elements 30 can includes a capacitor, a resistor, or an inductor.

It will be understood that the above particular embodiments and methods are shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

1. A PCB comprising:
a mounting surface defining. two connector outlines arranged in a back-to-back fashion and having a common side;
a face-down connector socket and a face-up connector socket selectively mounted to the mounting surface within the corresponding connector outlines; and
a plurality of electronic components mounted to the mounting surface, outside the connector outlines.

2. The PCB of claim I, wherein the PCB comprises a line of pads arranged along the common side and across the two connector outlines, each of the connector sockets defining an insertion groove in a side surface thereof and comprising a set of pins extending from a bottom surface thereof and connected to the pads, the pins of the face-down connector socket extending to a bottom portion of the insertion groove, and the pins of the face-up connector socket extending to an upper portion of the insertion groove.
